(19) United States
(12) Patent Application Publication
(10) Pub. No.: US 2025/0295549 A1
(43) Pub. Date: Sep. 25, 2025

(54) WHEELED WALKING AID WITH SWITCHABLE WHEEL DIRECTIONS FOR IN-PLACE ROTATION

(71) Applicant: Lindsay Kim, Chappaqua, NY (US)

(72) Inventor: Lindsay Kim, Chappaqua, NY (US)

(21) Appl. No.: 19/200,659

(22) Filed: May 7, 2025

(51) Int. Cl. A61H 3/04

(52) U.S. Cl. CPC A61H 3/04; A61H 2201/5025

(57) ABSTRACT

A walking aid apparatus is provided with selectively adjustable wheel orientations to enable both linear movement and in-place rotation, improving maneuverability in confined spaces. In various embodiments, the apparatus includes at least two wheels mounted to legs of a walker, each wheel capable of switching between a first state—aligned in parallel for forward motion—and a second state-angled such that the extended axes of rotation intersect at a central pivot point, enabling rotation without lifting. The switching mechanism may be actuated electrically, mechanically, or electro-mechanically, and may be user-controlled via a button, lever, or toggle. The system may be implemented on walkers with two or four wheels, offering increased stability over traditional swivel caster systems while preserving functional versatility. The invention enhances mobility and control for users with limited strength or dexterity, particularly in tight or obstacle-laden environments.

### BACKGROUND

The present invention relates generally to mobility assistance devices, and more particularly to a walking aid equipped with wheels on its front legs-commonly known as a front wheel walker.

Front wheel walkers offer advantages over traditional non-wheeled walkers, particularly by enabling users to move the device forward without the need to lift it. This reduces the physical effort required for forward movement, thereby improving ease of use.

In conventional front wheel walkers, the wheels are typically mounted using fixed casters, which constrain wheel movement to a straightforward direction. Although an alternative approach could involve using swivel casters-allowing the wheels to freely rotate in any direction—this configuration often compromises stability. Freely rotating front wheels may cause the walker to veer unexpectedly while being pushed, requiring additional user effort to maintain a straight path. Moreover, when the user's weight is applied to the walker, swivel casters may allow the front legs to shift unpredictably, potentially resulting in unsafe or unstable conditions.

A limitation of fixed-direction front wheels is that they restrict maneuverability, particularly when the user needs to perform an in-place rotation. Situations such as using a bathroom, navigating within an elevator, or making a tight turn in confined spaces may require such rotational movement. Without swivel casters, the user must lift the entire walker—or at least the front legs—to achieve rotation, which can be physically demanding.

The present invention addresses these shortcomings by providing a front wheel walker with wheels that have switchable directional settings. This configuration enables in-place rotation when needed, without relying on swivel casters, thereby maintaining the walker's overall stability during use.

### SUMMARY

Embodiments of the present invention are directed to a front wheel walker with front wheels that are switchable between two predetermined directional settings. In a first setting, the wheels are aligned in a fixed, straight-forward direction for stable linear movement. In a second setting, the wheels are oriented to enable in-place rotation of the walker around the approximate center of the user's foot placement.

In one non-limiting embodiment, switching between wheel directions is controlled by an electric switch connected to an actuator and powered by a battery. In another non-limiting embodiment, the switching mechanism is powered manually through user-applied force, without the need for electrical components.

The invention may also be applied to walkers equipped with wheels on all four legs, wherein at least two of the wheels have switchable directions. This enables in-place rotation without the use of swivel casters, thereby maintaining improved stability and safety.

Additional technical features and advantages of the present invention will become apparent from the following detailed description and the accompanying drawings. These embodiments and aspects are considered part of the claimed invention and may be used in combination or separately to achieve the desired functionality.

### BRIEF DESCRIPTION OF THE DRAWINGS

The specifics of the exclusive rights described herein are particularly pointed out and distinctly claimed in the claims at the conclusion of this specification. The foregoing and other features and advantages of the embodiments of the invention will become more apparent from the following detailed description taken in conjunction with the accompanying drawings, in which:

FIG. 1A illustrates a front wheel walker with the wheels set in the first directional configuration for forward movement;

FIG. 1B illustrates the same front wheel walker with the wheels set in the second directional configuration for in-place rotation;

FIG. 2A is a top view of the walker depicted in FIG. 1A;

FIG. 2B is a top view of the walker depicted in FIG. 1B;

FIG. 3 is a top view of the front wheel walker during in-place rotation;

FIG. 4 illustrates one embodiment of a mechanism for switching the wheel directions;

FIG. 5A is a top view of a four-wheeled walker having two wheels with switchable directions, shown in the first directional setting for forward movement;

FIG. 5B is a top view of the four-wheeled walker of FIG. 5A, with the two switchable wheels in the second directional setting for in-place rotation;

FIG. 5C is a top view of an embodiment of a four-wheeled walker that incorporates a parallel adjustable directional steering mechanism, in addition to the features shown in FIGS. 5A and 5B;

FIG. 6 is a top view of the four-wheeled walker during in-place rotation, corresponding to FIGS. 5A and 5B;

FIG. 7 is a top view of a four-wheeled walker where all four wheels have direction-switching functionality, with the wheels in the second directional setting for in-place rotation;

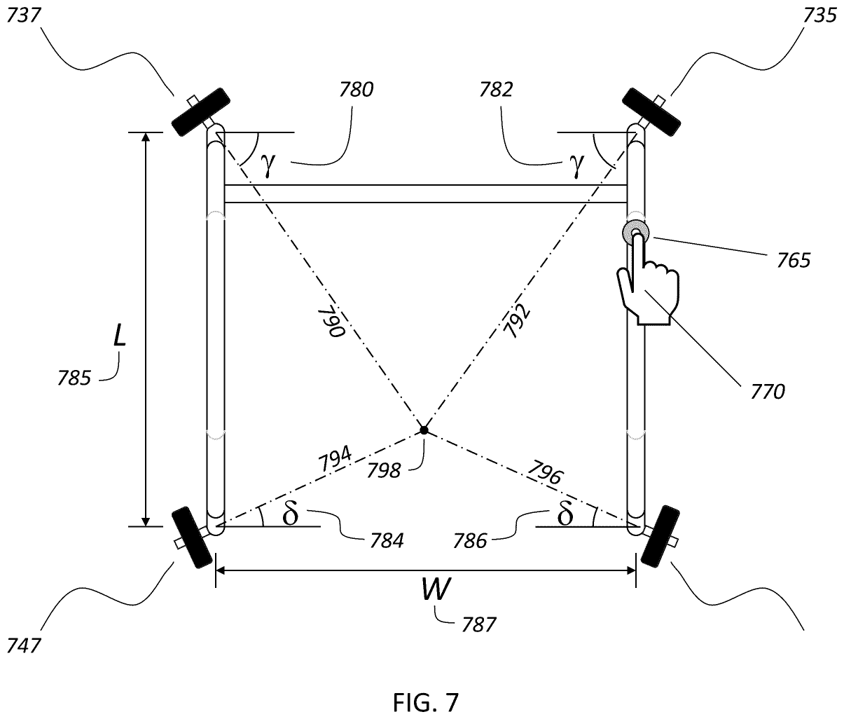

FIG. 8 is a top view of the walker shown in FIG. 7 during in-place rotation.

In the accompanying figures and the following detailed description of the illustrated embodiments, various components are identified with two-to four-digit reference numerals. With minor exceptions, the leftmost digit(s) of each reference number correspond to the figure in which the element is first introduced.

### DETAILED DESCRIPTION

The term “exemplary” as used herein means “serving as an example, instance, or illustration.” Any embodiment described as exemplary is not necessarily preferred or more advantageous over other embodiments. All embodiments described in this Detailed Description are provided to enable those skilled in the art to make or use the invention, and are not intended to limit the scope of the invention, which is defined by the claims.

### General Overview

One or more embodiments of the present invention address the limitations of conventional walkers by introducing wheels with two distinct states of orientation. In the first state, the wheels are aligned for straight forward movement. In the second state, the wheels are configured to enable in-place rotation of the walker. Switching between these two states occurs only when triggered by the user; otherwise, the wheels remain fixed in their current orientation.

### Front Wheel Walker Embodiment

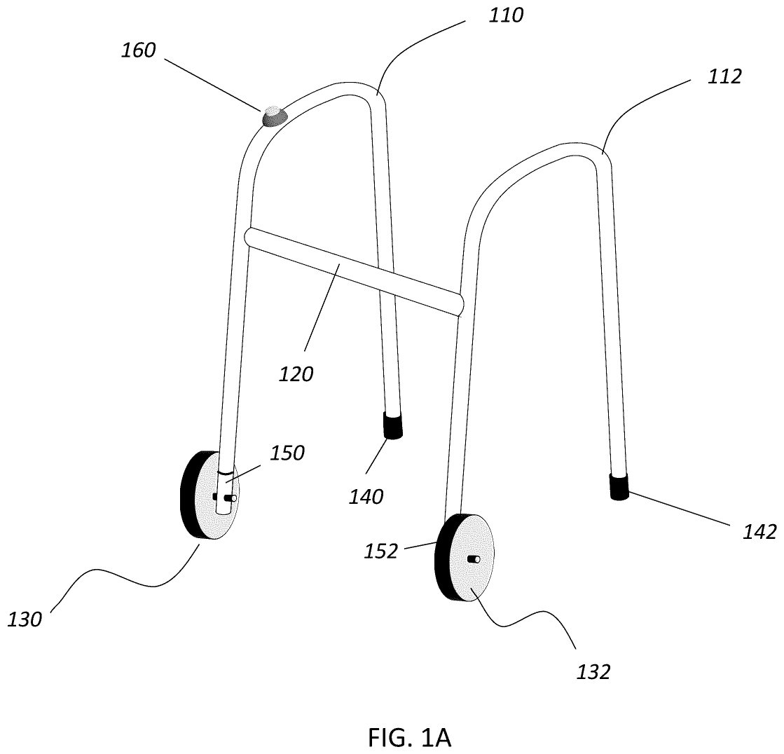

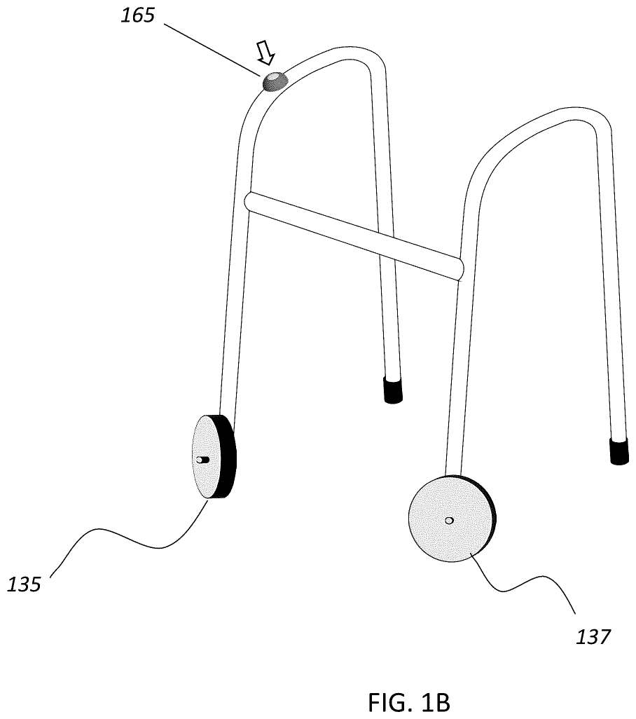

Turning to a more detailed embodiment, FIG. 1A depicts a front wheel walker in the first wheel orientation state. FIG. 1B shows the same walker in the second, in-place rotation state.

Referring to FIG. 1A, the walker includes a right frame (110), a left frame (112), a connecting brace (120), a right wheel (130), a left wheel (132), a right leg tip (140), a left leg tip (142), a rotatable right wheel caster (150), a rotatable left wheel caster (152), and a direction control button (160). All components except 150, 152, and 160 are typical of conventional front wheel walkers.

In standard walkers, wheel axles are fixed directly to the legs, lacking separate casters or incorporating non-rotatable ones. In contrast, casters 150 and 152 in this invention can rotate relative to the frame legs (110 and 112), allowing directional adjustment.

To preserve stability, the caster orientation is limited to two discrete angles. In FIG. 1A, the caster angle corresponds to straight forward movement (the first state). FIG. 1B shows the second state, where the wheels are rotated for in-place rotation. Transitioning from the first to the second state involves rotating the left wheel and caster (132 and 152) clockwise by a predetermined angle (a), and the right wheel and caster (130 and 150) counterclockwise by the same angle.

The transition is initiated by user actuation of the control button (160). By default, the walker is in the first state. When the button is pressed, the wheel casters rotate to enter the second state. This rotation can be driven electrically, mechanically, or by a hybrid electromechanical system.

Additional walker features such as foldable frames for portability, though not shown in FIGS. 1A and 1B, may be integrated without impacting the present invention.

### Top View and Rotation Behavior

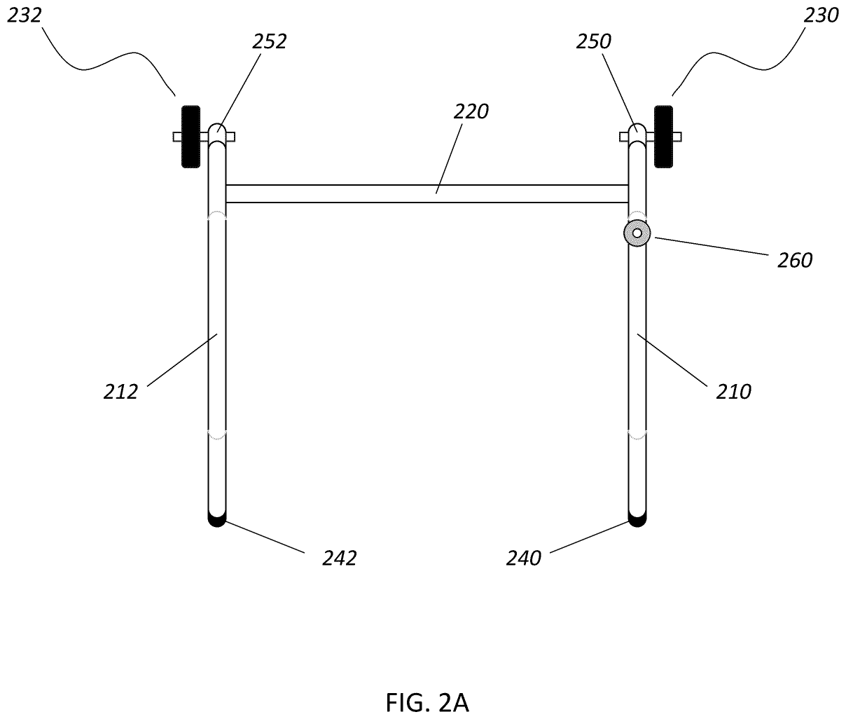

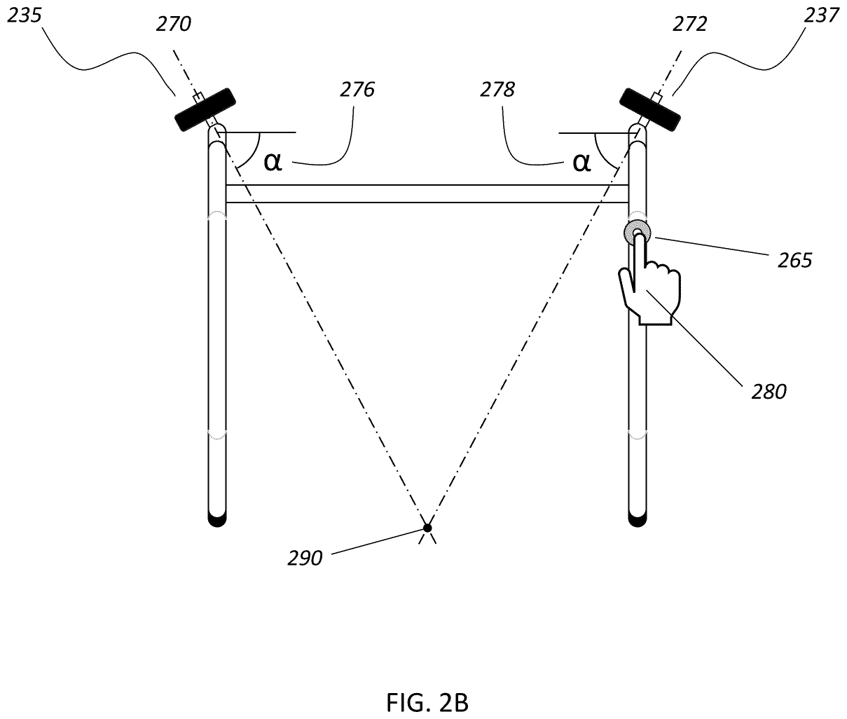

FIGS. 2A and 2B provide top views of the walker in the first and second states, respectively. In FIG. 2A, the left and right wheels (230, 232) are parallel, enabling straight movement. When the user presses the button (265), the left wheel (235) rotates clockwise by angle α (276), and the right wheel (237) rotates counterclockwise by angle α (278).

In FIG. 2B, extension lines (270, 272) of the left and right wheel axes intersect at a pivot point (290), which enables in-place rotation.

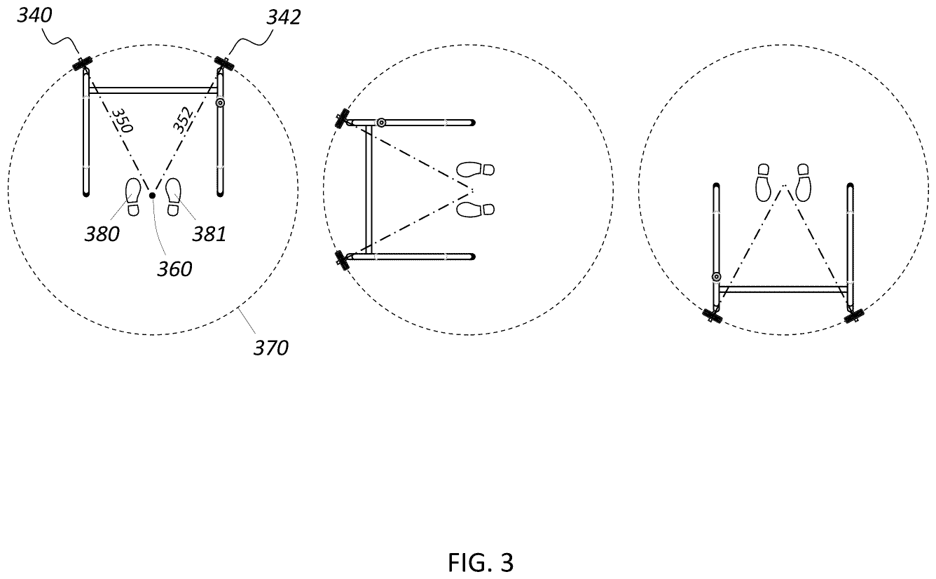

FIG. 3 further illustrates the in-place rotation process. View 310 shows the initial position. View 320 shows the walker after a 90° counterclockwise rotation, and view 330 after a 180° rotation. Footprints (380, 381) show that when the pivot point (360) is near the user's foot center, minimal user movement is needed during rotation.

### Mechanism for Switching States

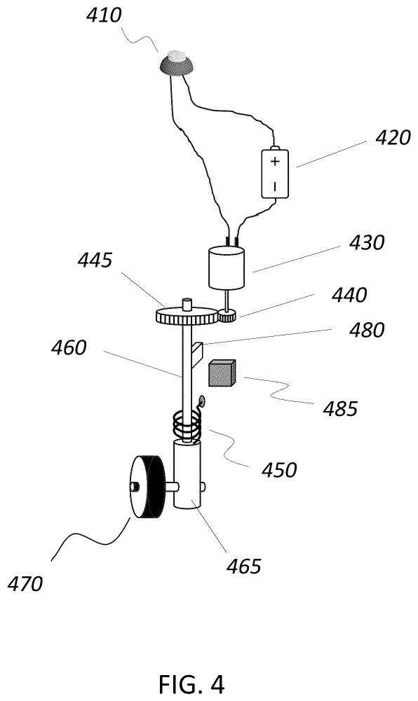

FIG. 4 illustrates an exemplary electromechanical switching mechanism. When the user presses the button (410), a battery (420) powers an electric motor (430) that rotates the caster shaft (460) via gears (440, 445). A bit (480) attached to the shaft is constrained by a fixed stopper (485), limiting rotation. A return spring (450) resets the caster to the default position when the button is released.

In an alternate embodiment, the stopper position is adjustable, allowing the caster angle α to be customized to the user's preference.

In another embodiment, the button is a toggle switch that switches states with each press, eliminating the need to hold the button continuously. Alternatively, a mechanical lever may be used to directly rotate the casters.

The mechanism shown in FIG. 4 is exemplary; those skilled in the art can devise alternative implementations using mechanical, electrical, or electromagnetic systems. The core functionality remains unaffected by the specific mechanism employed.

### Four-Wheeled Walker Embodiment

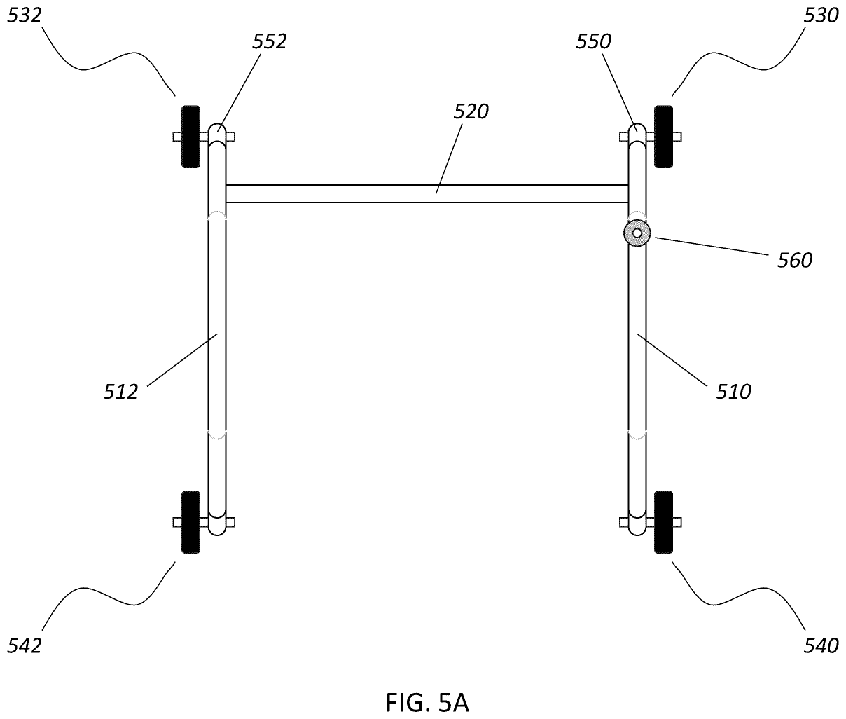

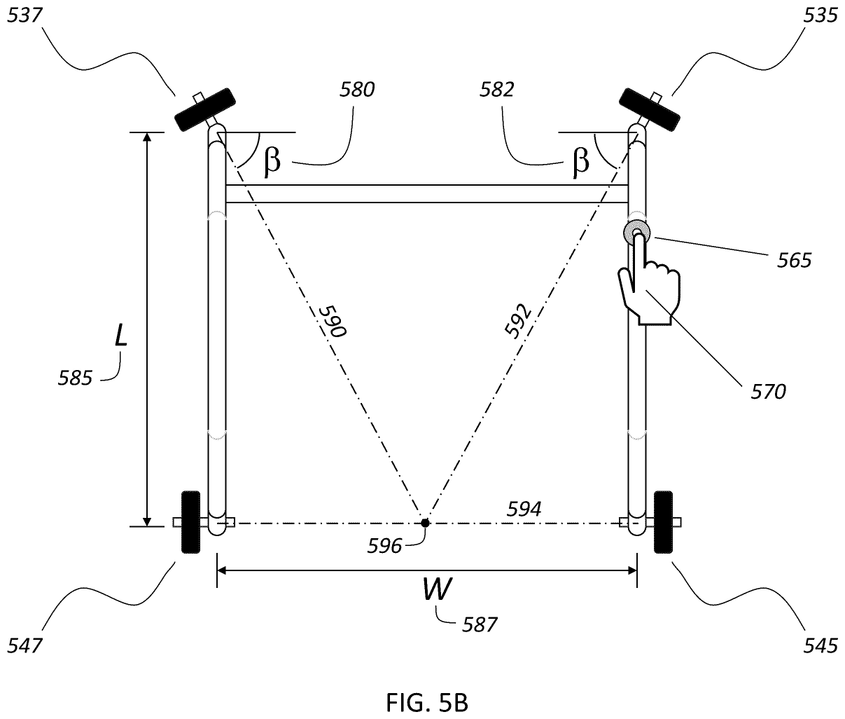

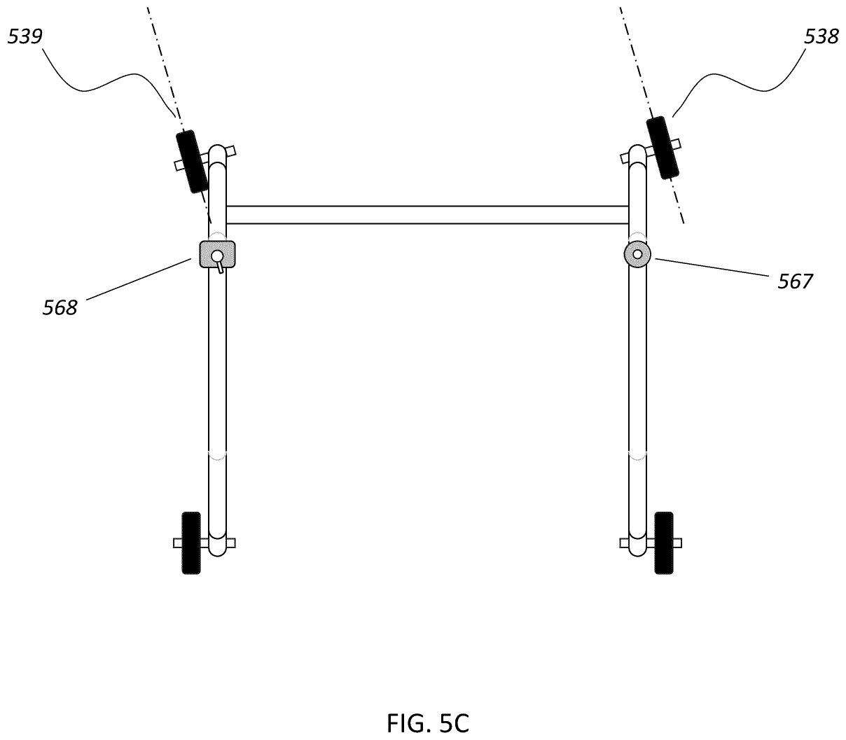

FIGS. 5A and 5B illustrate a four-wheeled walker embodiment. Compared to FIG. 2A, the rear leg tips (240, 242) are replaced with rear wheels (540, 542) attached directly to the frames (510, 512) without casters, thus fixed in direction.

As in the previous embodiment, the front wheels switch between two states: forward movement (FIG. 5A) and in-place rotation (FIG. 5B). In the second state, the front left wheel and caster (532, 552) rotate clockwise by angle β (580), while the front right wheel and caster (530, 550) rotate counterclockwise by β (582).

For proper in-place rotation, the axes of all four wheels (590, 592, 594) must intersect at a common pivot point (596). Given walker width W (587) and length L (585), the angle β must satisfy the equation:

$$L = W / ( 2 \times tan ( β ) )$$

To ensure safety when all legs are wheeled, friction or braking means-such as hand-controlled brakes on rear wheels—may be added, as commonly found in rollators. However, these features are outside the scope of this invention.

### Adjustable Directional Steering and Enhanced Rotation

In a further embodiment, the front wheel directions in the first state can be adjusted to point slightly left or right while remaining parallel. A control stick (568) enables this adjustment, allowing the walker to move in a curved path. Switching between states remains controlled by a button (567), and wheel rotation may be achieved via servo motors.

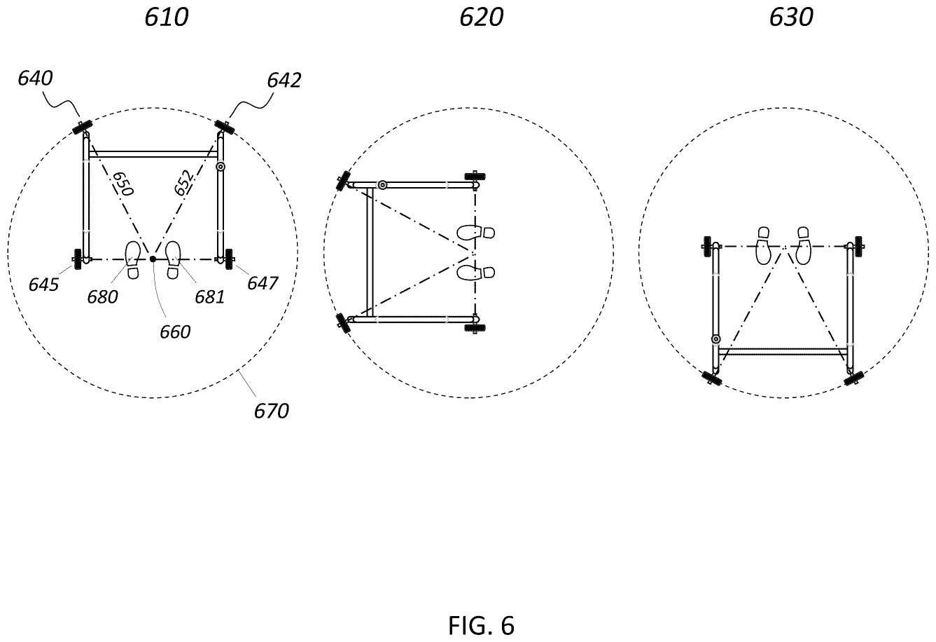

FIG. 6 shows the walker during in-place rotation. View 610 is the initial state, 620 shows a 90° counterclockwise turn, and 630 shows a 180° rotation. Footprints (680, 681) and pivot point (660) again demonstrate minimized user movement.

### Four-Wheel Direction Switching

In yet another embodiment, all four wheels have direction-switching capability. In the first state, all wheels are aligned straight. In the second state, front wheels rotate by angle γ (780, 782) and rear wheels by angle δ (784, 786), both symmetrically. This configuration results in a smaller rotation radius compared to adjusting only the front wheels.

To enable effective in-place rotation, the extended axes of all four wheels (790, 792, 794, 796) intersect at a common pivot point (798). The angles must satisfy the equation:

$$L = W / ( 2 \times ( tan ( γ ) + tan ( δ ) ) )$$

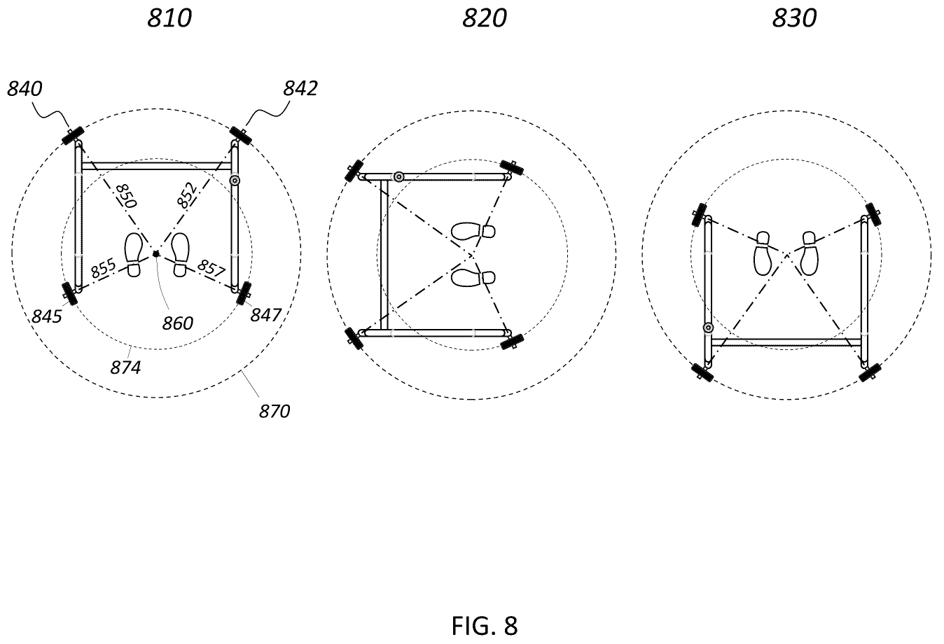

FIG. 8 shows the walker during in-place rotation. View 810 is the initial state, 820 shows a 90° counterclockwise turn, and 830 shows a 180° rotation.

### Terminology and Interpretation

As used in this specification, terms such as “comprises,” “includes,” “has,” and similar expressions indicate non-exclusive inclusion. A device or method that comprises a list of elements is not limited to those elements but may include others not explicitly mentioned.

References to “one embodiment,” “an embodiment,” or “example embodiment” do not imply that all embodiments include the described feature. Features described in one embodiment may be implemented in others, even if not explicitly stated.

The various embodiments described herein are illustrative and not exhaustive. Modifications and alternatives will be apparent to those skilled in the art without departing from the scope of the invention. The terminology used aims to clearly communicate the technical innovations and advantages of the invention.

1. A walking aid apparatus, comprising:
(a) a user input mechanism configured to generate a control signal representing at least two distinct directional states;
(b) a plurality of legs, each leg comprising:
(i) a wheel; and
(ii) a wheel mounting assembly configured to allow adjustment of the wheel's orientation;
(c) one or more actuators operatively connected to the wheel mounting assemblies, the actuators being responsive to the control signal to change the orientations of the wheels, wherein:
(i) in a first directional state, the actuators align the wheels such that extension lines of the rotational axes of the wheels intersect at a common point, enabling in-place rotation of the apparatus; and
(ii) in a second directional state, the actuators align the wheels such that their rotational axes are parallel, enabling forward linear movement of the apparatus.

2. A method of operating a walking aid, the method comprising:
(a) receiving a first user input to set a plurality of wheels to a forward movement configuration in which their rotational axes are parallel;
(b) receiving a second user input to set the wheels to a rotation configuration in which extensions of their rotational axes intersect at a common point; and
(c) actuating one or more wheel direction mechanisms in response to said inputs to switch between the two configurations.

3. A walking aid apparatus, comprising:
(a) four legs, each leg including a wheel mounted via a rotatable caster assembly;
(b) a control system including a user-operable switch and one or more actuators configured to rotate at least two of the caster assemblies;
(c) a control mechanism configured to adjust the wheel orientations based on user input;
(d) wherein the orientations of the wheels are switchable between a linear walking mode and an in-place rotation mode.

4. The apparatus of claim 1, wherein the user input mechanism comprises a button, switch, lever, or touchscreen.

5. The apparatus of claim 1, wherein the actuators are selected from the group consisting of electric motors, servo motors, mechanical linkages, hydraulic actuators, and spring-loaded mechanisms.

6. The apparatus of claim 1, wherein the wheel mounting assembly includes a rotatable caster assembly coupled to the leg through a pivot joint.

7. The apparatus of claim 1, wherein the control signal is transmitted to a microcontroller that drives the actuators.

8. The apparatus of claim 1, wherein the actuators rotate the wheels by a predetermined angle between approximately 10 degrees and 45 degrees.

9. The apparatus of claim 1, wherein the actuators automatically return the wheels to a default orientation upon release of the user input mechanism.

10. The apparatus of claim 1, wherein the wheels are located on front legs and the rear legs comprise fixed tips or non-rotatable wheels.

11. The apparatus of claim 1, wherein all four legs include wheels, and the orientations of both front and rear wheels are adjusted by the actuators.

12. The apparatus of claim 11, wherein the wheel orientations in the first directional state are symmetrically angled inward or outward relative to a pivot point located approximately beneath a user's center of gravity.

13. The apparatus of claim 1, further comprising a tuning mechanism configured to adjust the wheel orientations in the first directional state.

14. The apparatus of claim 1, further comprising a secondary input mechanism configured to adjust the parallel orientation of the wheels in the second directional state, such that the apparatus can move diagonally or along a curved path.

15. The method of claim 2, further comprising returning the wheels to a default orientation when the user input is released.
